(19) United States
(12) Patent Application Publication
(10) Pub. No.: US 2017/0093825 A1
(43) Pub. Date: Mar. 30, 2017

(54) SDN CONTROLLER AND METHOD OF IDENTIFYING SWITCH THEREOF

(71) Applicant: Electronics and Telecommunications Research Institute, Daejeon-si (KR)

(72) Inventors: Sae Hyong PARK, Daejeon-si (KR); Tae Hong KIM, Daejeon-si (KR); Soo Myung PARK, Daejeon-si (KR); Ji Soo SHIN, Daejeon-si (KR); Chang Gyu LIM, Daejeon-si (KR)

(21) Appl. No.: 15/229,652

(22) Filed: Aug. 5, 2016

(30) Foreign Application Priority Data
Sep. 30, 2015 (KR) 10-2015-0138135

(51) Int. Cl. H04L 29/06; H04L 29/08; G06F 13/40; H04W 76/02

(52) U.S. Cl. CPC H04L 63/061; H04W 76/021; H04L 67/141; G06F 13/4022

(57) ABSTRACT

A software-defined network (SDN) controller and its method for authenticating switches through encryption of the switches' identifiers. The authenticating method may include obtaining a data path identifier (DPID)-based authentication code, authenticating a received and encrypted session key by using the DPID-based authentication code, determining the presence of another switch having an identical DPID as that of the authenticated switch, and adding a modifier to the DPID and storing the modified DPID if indeed there is another switch with an identical DPID present.

### CROSS-REFERENCE TO RELATED APPLICATION(S)

This application claims priority from Korean Patent Application No. 10-2015-0138135, filed on Sep. 30, 2015, in the Korean Intellectual Property Office, the disclosure of which is incorporated herein by reference in its entirety.

### BACKGROUND

1. Field

The following description relates to a software-defined networking (SDN) technology, and more particularly, to an apparatus and method for effective virtualization of a control plane and data plane, thus improving the stability, scalability, and manageability of a network.

2. Description of Related Art

Software-defined networking allows a user to have control over all underlying network devices (e.g., routers and switches) regardless of what they maybe, while enabling a separate software controller to control traffic flow.

Open Networking Foundation, which is a standard-setting body that promotes the standardization of OpenFlow technology designed for SDN, defines an interface between hardware (switch) and a controller (network operating system). OpenFlow is a protocol that separates a control plane from a physical network and describes the interaction between the control plane and a data plane, wherein the control plane controls the transmission of packets over a network, and the data plane enables data transfer.

With the expansion of SDN technologies in a variety of fields, issues regarding stability, scalability, and manageability may arise in the application of a SDN network. As such, a problem that occurs in the event that a controller fails to authenticate a switch may prove to be fatal in terms of the stability of the network. This is because if the controller does not authenticate a switch, a particular packet destined for that specific switch may be redundantly transmitted to other switches, and so the specific switch cannot receive the designated packet. This may not only lead to performance degradation, but also causes network service failure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The following description relates to a software-defined networking (SDN) controller that authenticates switches through encryption of switches' identifiers, thereby improving stability and availability, and a method of identifying an OpenFlow switch of the SDN controller.

The following description relates to a SDN controller that distinguishes two or more switches having the same identifiers, thereby improving stability and availability, and a method of the SDN controller for identifying an OpenFlow switch of the SDN controller.

In one general aspect, there is provided a method of identifying switches in a software-defined networking (SDN) network, the method including: obtaining a data path identifier (DPID)-based authentication code by exchanging feature status messages with a switch that attempts to make a connection; configuring settings of the switch by exchanging setting configuration messages with the switch; in response to receiving a session key with encrypted DPID from the switch, authenticating the session key by using the DPID-based authentication code; determining the presence of another switch that has the same DPID as that of the authenticated switch; and in response to the presence of another switch having the same ID as that of the authenticated switch, adding a modifier to the DPID and storing the modified DPID.

In another general aspect, there is provided a software-defined networking (SDN) controller including: a database; a connection processor configured to obtain a data path identifier (DPID)-based authentication code by exchanging feature status messages with a switch that attempts to make a connection, and configure settings of the switch by exchanging setting configuration messages with the switch; an authenticator configured to, in response to receiving a session key with an encrypted session key from the switch, authenticate the session key based on the DPID-based authentication code; and a DPID manager configured to search the database for the presence of another switch having the same DPID as that of the authenticated switch, and in response to said presence, add a modifier to the DPID and store the modified DPID in the database.

Other features and aspects will be apparent from the following detailed description, the drawings, and the claims.

### BRIEF DESCRIPTION OF THE DRAWINGS

FIG. 1 is a diagram illustrating a general software-defined networking (SDN) network.

FIG. 2 is a diagram illustrating a SDN network according to an exemplary embodiment.

FIG. 3 is a diagram illustrating the controller of FIG. 2.

FIG. 4 is a signal flowchart illustrating an example in which the controller identifies the switches in the SDN network according to the exemplary embodiment.

FIG. 5 is a flowchart illustrating a method of an SND controller to identify a switch according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, embodiments of the invention will be described in detail with reference to the accompanying drawings. Terms used herein are selected by considering functions in the embodiment and meanings may vary depending on, for example, a user or operator's intentions or customs. Therefore, in the following embodiments, when terms are specifically defined, the meanings of terms should be interpreted based on those definitions, and otherwise, should be interpreted based on general meanings recognized by those skilled in the art. In this specification, a case in which a first material layer is formed on a second material layer may be interpreted to have both a case in which the first material layer is directly formed on the second material layer and a case in which a third material layer (an upper material layer) is interposed between the first material layer and the second material layer when there is no description explicitly excluded.

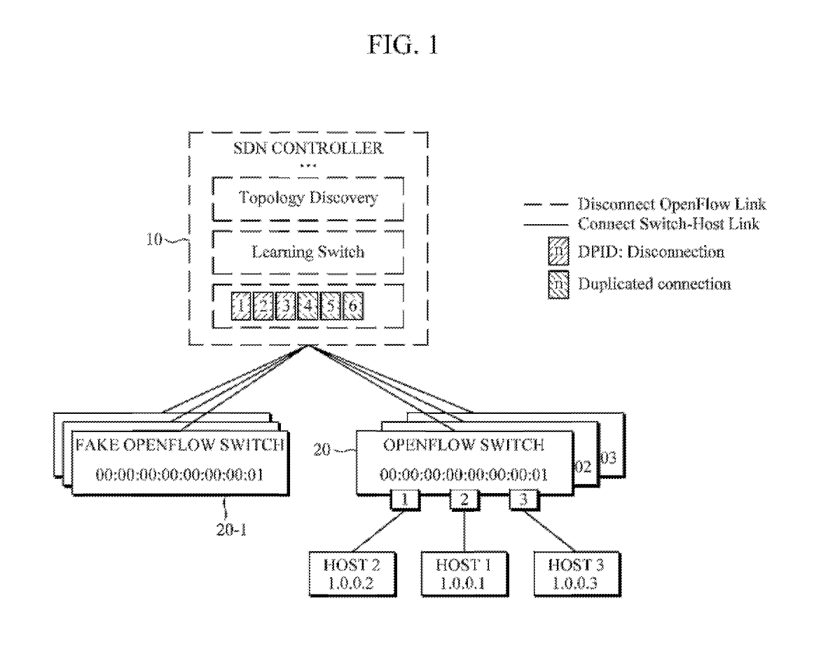

FIG. 1 is a diagram illustrating a general software-defined networking (SDN) network.

Referring to FIG. 1, the SDN network includes a SDN controller 10 and a plurality of OpenFlow switches 20 and 20-1. Here, it is assumed that the OpenFlow switch 20 and the fake OpenFlow switch 20-1 have the same data path identifiers (DPIDs), ‘00:00:00:00:00:00:00:01’. The controller 10, hence, may send a packet to the OpenFlow switch 20 and a duplicated packet to the fake OpenFlow switch 20-1, or may send a packet that has to be sent to the OpenFlow switch 20 only to the fake OpenFlow switch 20-1, but not to the OpenFlow switch 20. Such incidents may degrade the network performance, and cause disconnection or interruption of a network service.

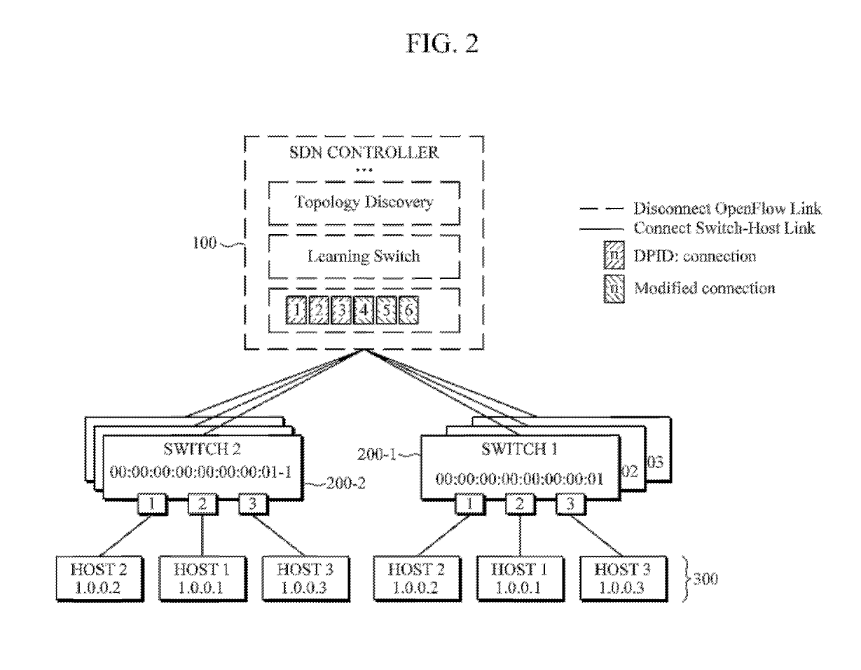

FIG. 2 is a diagram illustrating a SDN network according to an exemplary embodiment.

Referring to FIG. 2, the SDN network includes a SDN controller (hereinafter, will be referred to as a “controller”) 100 to which a plurality of switches 200-1 and 200-2 are connected, and a plurality of hosts 300 that are connected to each switch. Although not illustrated, layer 1 controllers are ultimately connected to layer 2 controllers. While FIG. 2 illustrates six hosts 300, six switches 200-1 and 200-2, and a single controller 100, aspects of the present disclosure are not limited thereto.

The controller 100 refers to a functional entity that controls elements (e.g., switches and routers) for controlling traffic flow, and the physical implementation or a location for implementation thereof will not be limited. For example, the controller 100 may be a functional entity that is defined by ONF, IETF, ETSI, and/or ITU-T. According to an exemplary embodiment, in the case where authenticated different switches use the same DPID, the controller 100 adds different modifiers to the respective DPIDs, except one DPID, and manages the DPIDs.

The plurality of switches 200-1 and 200-2 are functional entities that substantially forward, switch, or route traffic (or packets), and may be in the form of switches, routers, switch components, router components, or forwarding components that are defined by ONF, IETF, ETSI, and/or ITU-T. In addition, according to one exemplary embodiment, the plurality of switches 200-1 and 200-2 include the DPIDs and flow tables, and have an additional function for DPID authentication.

The embodiment shown in FIG. 2 assumes that switch 1 200-1 and switch 2 200-2 have the same DPIDs. According to the exemplary embodiment, the controller 100 changes the original DPID of switch 2 200-2, i.e., “00:00:00:00:00:00:00:01” to “00:00:00:00:00:00:00:01-1” and manages the changed DPID. By doing so, it is possible to build various networks using the switches with the same DPIDs.

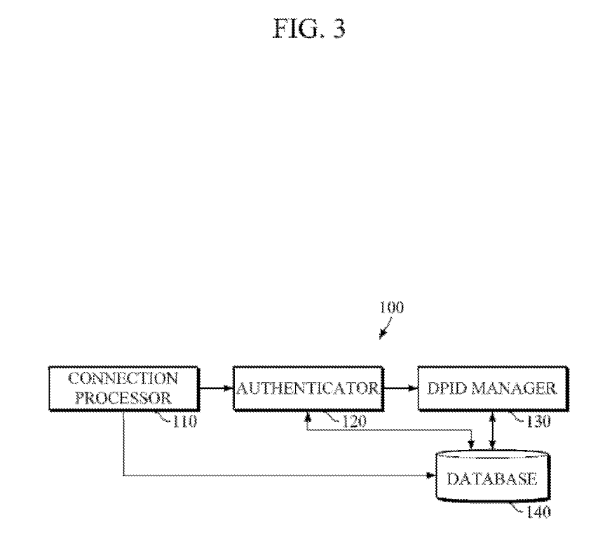

FIG. 3 is a diagram illustrating the controller of FIG. 2.

Referring to FIG. 3, the controller 100 includes a connection processor 110, an authenticator 120, a DPID manager 130, and a database 140.

The connection processor 110 obtains a DPID-based authentication code by exchanging feature status messages with a switch that makes attempts to connect to the controller 100, and then the connection processor 110 stores the obtained code in the database 140 and sets the settings of the switch by exchanging messages for settings configuration. Here, the feature status messages contain actions that can be processed, port information, and a DPID-based authentication code.

The authenticator 120 receives a session key with an encrypted DPID from the switch, and authenticates the session key using the DPID-based authentication code. The session keys that are received at designated intervals from the switch are authenticated. The authenticator 120 terminates the connection to the switch if the authentication of session key has failed.

The DPID manager 130 searches the database 140 for the presence of another switch having the same DPID as the one that the authenticated switch has, and if indeed the switch with the same DPID is found, the DPID manager 130 adds a modifier to the found switch and stores it in the database 140. At this time, the DPID manager 130 determines that there is another switch having the same DPID if switches with the same DPIDs have connection socket information that differ from each other. The DPID manager 130 also stores the connection socket information of the switch in the database 140. Meanwhile, if there is no switch that has the same DPID as that of the authenticated switch, the DPID manager 130 stores the DPID along with the connection socket information in the database 140.

The aforesaid configurations of the controller and the switch are representative configuration examples for switch identification according to the present disclosure, and the configurations thereof can vary depending on the implementation. Therefore, the configurations of the controller and the switch are not limited to the examples shown in FIGS. 2 and 3.

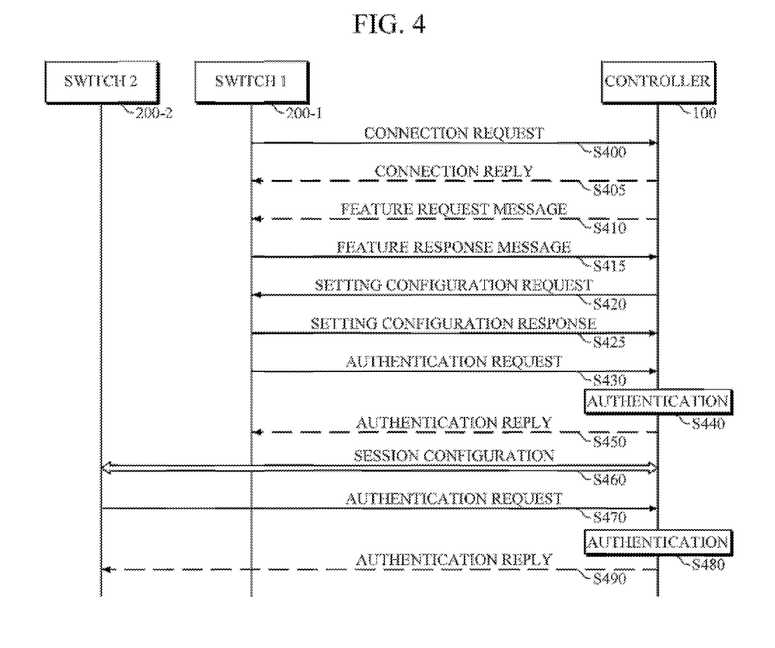

FIG. 4 is a signal flowchart illustrating an example in which the controller identifies the switches in the SDN network according to the exemplary embodiment. Here, for the convenience of understanding, the example assumes that switch 1 200-1 and switch 2 200-2 have the same DPID, “00:00:00:00:00:00:00:01”.

Referring to FIG. 4, switch 1 200-1 and the controller 100 carry out the task of configuring connection settings, as depicted in S400 to S425. The controller 100 obtains DPID-based encryption information as being feature status information.

In more detail, switch 1 200-1 attempts to connect to the controller 100 by sending a connection request message (HELLO message) to the controller 100, as depicted in S400, and the controller 100 responds to the request by sending a connection reply message (HELLO message) to switch 1 200-1, as depicted in S405. At this time, for connection settings between the controller 210 and the switches 220-1 and 200-2, not only TCP/IP, but also various transport layer protocols which allow communications between a controller and switches may be used.

Thereafter, the controller 100 sends a feature request message to switch 1 200-1, as depicted in S410, and in turn, switch 1 200-1 sends a feature response message to the controller 100, as depicted in S415. At this time, the feature request message contains DPID-based authentication code request information, and the feature response message contains actions that the controller can process, port information, and a DPID-based authentication code.

Then, the controller 100 sends a setting configuration message (Set Config message) to switch 1 200-1, as depicted in S420; switch 1 200-1, in turn, sends a setting configuration response message to the controller 100, as depicted in S425. At this time, the controller 100 configures the setting of switch 1 200-1 through ‘miss_send_len’ and flags.

Then, switch 1 200-1 generates a session key using a DPID and password thereof, periodically send the generated session key to the controller 100, and makes an authentication request (ECHO-REQUEST), as depicted in S430.

The controller 100 authenticates the session key, as depicted in S440, and if the authentication of the session key fails, the connection with switch 1 200-1 may be terminated. In addition, since the controller 100 is the first switch, it stores connection socket information and DPID in the database 140 as shown in Table 1 below.

TABLE 1

| SC | Modified DPID | Original DPID |
|---|---|---|
| 5 | null | 00:00:00:00:00:00:01 |

Thereafter, the controller 100 sends an authentication reply (ECHO_REPLY) in response to the authentication request (ECHO_REQUEST), as depicted in S450.

Here, the exemplary embodiment assumes that parameters and/or the message type (for example, ECHO REQUEST/REPLY) that are used are ones which have been defined by ONF, but aspects of the present disclosure are not limited to the definitions by ONF.

Then, switch 2 200-2, having the same DPID as that of first switch 200-1, “00:00:00:00:00:00:00:01”, attempts to connect to the controller 100 and establishes a session, as depicted in S460. These processes are the same as those of S400 to S425 described above, and hence detailed descriptions will be omitted.

Switch 2 200-2 creates a session key using its own DPID and password, and periodically sends the created session key to the controller to request the authentication (ECHO_REQUEST), as depicted in S460.

In response, the controller 100 authenticates the session key, as depicted in S480. Since switch 1 has the same identifier “00:00:00:00:00:00:00:01”, the controller 100 adds a modifier “01” to DPID to distinguish between switch 1 200-1 and switch 2 200-2, and stores the DPID along with the connection socket information in the database 140 as shown in Table 2 below.

TABLE 2

| SC | Modified DPID | Original DPID |
|---|---|---|
| 5 | null | 00:00:00:00:00:00:01 |
| 6 | 01 | 00:00:00:00:00:00:01 |

Then, the controller 100 sends an authentication reply (ECHO_REPLY) to switch 1 200-1 in response to the authentication request (ECHO_REQUEST), as depicted in S490.

Through the aforesaid method, a number of switches with the same DPID can continue to communicate with a single controller.

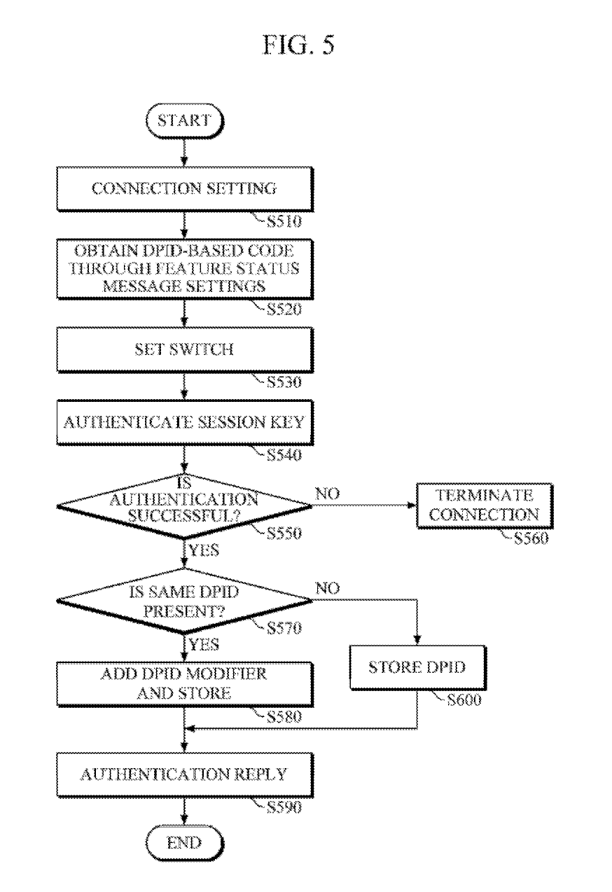

FIG. 5 is a flowchart illustrating a method of an SND controller to identify a switch according to an exemplary embodiment.

Referring to FIG. 5, the controller 100 sets settings for connection with a switch that attempts to connect, as depicted in S510, and obtains a DPID-based authentication code by exchanging feature status messages, as depicted in S520. Here, the feature status messages contain actions that can be processed, port information, and DPID-based authentication code. The authentication code may be either a symmetric code or an asymmetric code.

Then, the controller 100 configures settings of the switch by exchanging setting configuration messages with said switch, as depicted in S530. At this time, the controller 100 configures the settings of the switch by receiving ‘miss_send_len’ and flags.

In response to receiving a session key with encrypted DPID from the switch, the controller 100 authenticates the session key using the DPID-based authentication code, as depicted in S540. The session keys may be received at specific intervals.

The controller 100 determines whether the authentication of session key is successful, as depicted in S550, and if the authentication fails, terminates the connection with switch 1, as depicted in S560.

On the contrary, if the session key is authenticated, the controller 100 determines whether there is another switch that has the same DPID as the authenticated switch, as depicted in S570. At this time, the controller determines that there is another switch having the same DPID if switches with the same DPIDs have connection socket information that differ from each other.

If it is determined in S570 that there is another switch having the same DPID as that of the authenticated switch, the controller 100 adds a modifier to the DPID and stores the modified DPID. For example, the controller 100 may change the original DPID of the switch “00:00:00:00:00:00:00:01” to “00:00:00:00:00:00:00:01-1” and store the changed one. Then, the controller 100 sends a reply message regarding the session key authentication, as depicted in S590.

If it is determined in S570 that a switch that has the same DPID as that of the authenticated switch is not present, the controller 100 stores the DPID along with the connection socket information, as depicted in S600, and then sends a reply message regarding the session key authentication, as depicted in S590.

The present disclosure may be used together with TLS authentication/encryption, and may maximize the stability and availability of an SDN network that becomes more complex due to host virtualization. Furthermore, the present disclosure may maximize the stability and availability of an SDN network that becomes more complex due to host virtualization, as well as improve the stability and availability of the SDN network since it can distinguish two or more switches with the same identifiers

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of identifying switches in a software-defined networking (SDN) network, the method comprising:
obtaining a data path identifier (DPID)-based authentication code by exchanging feature status messages with a switch that attempts to make a connection;
configuring settings of the switch by exchanging setting configuration messages with the switch;
in response to receiving a session key with encrypted DPID from the switch, authenticating the session key by using the DPID-based authentication code;
determining the presence of another switch that has the same DPID as that of the authenticated switch; and
in response to the presence of another switch having the same ID as that of the authenticated switch, adding a modifier to the DPID and storing the modified DPID.

2. The method of claim 1, wherein the feature status message comprises actions that can be processed, port information, and a DPID-based authentication code.

3. The method of claim 1, wherein the authentication code comprises a symmetric code or an asymmetric code.

4. The method of claim 1, wherein the authenticating of the session key comprises receiving the session key from the switch at predetermined intervals.

5. The method of claim 1, further comprising:
in response to a failure of authentication of the session key, terminating the connection with the switch.

6. The method of claim 1, wherein it is determined that there is another switch that has the same DPID as that of the authenticated switch if the switches having the same DPIDs have different connection socket information from each other.

7. The method of claim 1, wherein the storing of the modified DPID comprises storing connection socket information of the switch.

8. The method of claim 1, further comprising:
in response to the absence of another switch having the same DPID as that of the authenticated switch, storing the DPID together with connection socket information.

9. A software-defined networking (SDN) controller comprising:
a database;
a connection processor configured to obtain a data path identifier (DPID)-based authentication code by exchanging feature status messages with a switch that attempts to make a connection, and configure settings of the switch by exchanging setting configuration messages with the switch;
an authenticator configured to, in response to receiving a session key with an encrypted session key from the switch, authenticate the session key based on the DPID-based authentication code; and
a DPID manager configured to search the database for the presence of another switch having the same DPID as that of the authenticated switch, and in response to said presence, add a modifier to the DPID and store the modified DPID in the database.

10. The SDN controller of claim 9, wherein the feature status message comprises actions that can be processed, port information, and a DPID-based authentication code.

11. The SDN controller of claim 9, wherein the authenticator is configured to authenticate the session key that is received from the switch at predetermined intervals.

12. The SDN controller of claim 9, wherein the authenticator is configured to, in response to a failure of authentication of the session key, terminate the connection with the switch.

13. The SDN controller of claim 9, wherein the DPID manager is configured to determine the presence of another switch having the same DPID as that of the authenticated switch if the switches having the same DPIDs have connection socket information that differ from each other.

14. The SDN controller of claim 13, wherein the DPID manager is also configured to store connection socket information of the switch.

15. The SDN controller of claim 9, wherein the DPID manager is configured to, in response to the absence of another switch having the same DPID as that of the authenticated switch, store the DPID together with connection socket information.
